(19) United States
(12) Patent Application Publication
(10) Pub. No.: US 2005/0012001 A1
(43) Pub. Date: Jan. 20, 2005

(54) Method for forming bases for rotable office chairs and base obtained by the method

(76) Inventor: Stefano Liviero, Veneto (IT)

Correspondence Address: Hoffman Wasson & Gitler, 2461 South Clark Street, Crystal Center 2 -Suite 522, Arlington, VA, 22202, US

(21) Appl. No.: 10/500,462

(22) PCT Filed: Jan. 17, 2003
(86) PCT No.: PCT/EP03/00442

(30) Foreign Application Priority Data
Jan. 24, 2002 (IT) VE2002A00005

(51) Int. Cl. F16M 11/20; A47B 91/00

(52) U.S. Cl. 248/188.7

(57) ABSTRACT

A method for forming rotatable bases for offices chairs characterised by structurally joining together at least two half-shells (6, 6′) to form overall a plurality of spokes (2) each consisting of an elongated box-shaped body, and a central ring (4) into which a column is inserted.

This invention relates to a method for forming bases for rotatable office chairs and a base obtained by the method.

Office chairs are known comprising a spoke-type base with feet or wheels and a column mounted on said base and provided with a spring, generally in the form of a gas piston, to adjust the height of the sitting plane from the floor.

A known type of such a base is obtained in one injection moulding step from thermoplastic materials, and presents a substantially U-shaped open cross-section to enable the male die punch to be extracted.

The current regulations regarding safety and reliability tests for chairs require that the base be subjected to a series of verification tests (compressions) to verify their structural strength and the absence of permanent deformations which could prejudice their integrity.

The load conditions to which a single base spoke is subjected can be schematically represented by likening the spoke to a beam fixed at one end to the central core and stressed by a vertical force acting upwards from below and applied at the point to which the wheel or foot is connected. This beam is therefore subjected to straight flexure with its lower fibres subjected to tension and its upper fibres to compression, and presents its maximum bending moment in correspondence with its fixed end, i.e. where the spoke joins the central core.

The base spokes are also subjected to twisting due to the misalignment between the wheel and the pin connecting the wheel to the base.

In those bases constructed in accordance with the known art the spokes are formed with an inverted U profile, i.e. with the material-lacking region lying precisely where the fibres are subjected to high tension forces.

Consequently to resist these stresses, the spokes are reinforced by increasing their thickness, adding reinforcement elements and inserting structural metal parts, or by using materials with better mechanical characteristics.

However all these additions result in considerable increases in material and manufacturing costs.

An object of the invention is to eliminate these drawbacks by providing a chair base presenting high resistance to the stresses concerned.

Another object of the invention is to provide a base which enables the price/performance trade-off to be shifted to a level not attainable by current bases present on the market.

These and other objects which will be apparent from the ensuing description are attained according to the invention by a method for forming office chair bases as described in claim 1.

A preferred embodiment of the invention is described in detail below by way of non-limiting example with reference to the accompanying drawings, in which:

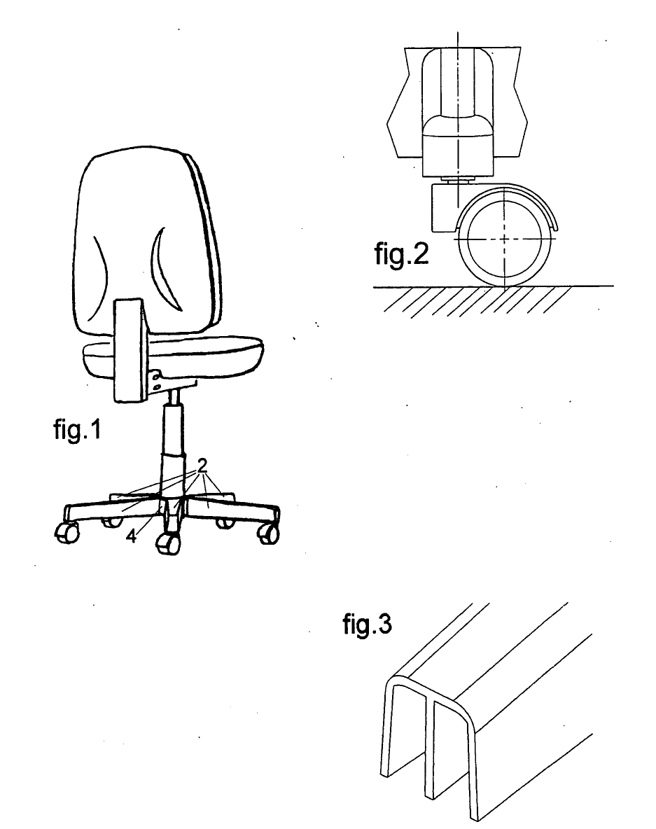

FIG. 1 shows an example of a chair with base and wheels;

FIG. 2 shows an enlargement of the base in the wheel connection region;

FIG. 3 is a perspective sectional view of a base spoke of the known art;

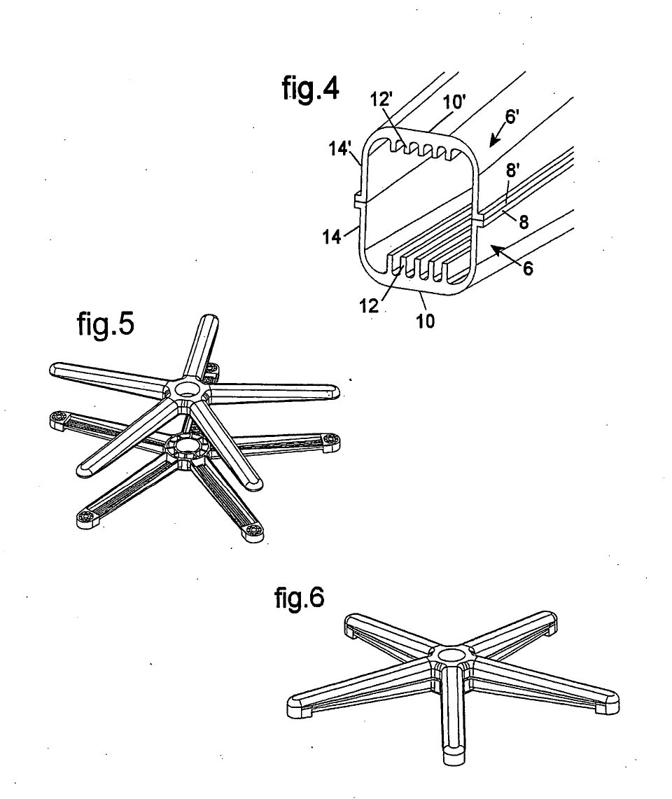

FIG. 4 is a perspective sectional view of a base spoke obtained in accordance with the invention;

FIG. 5 shows the two half-shells to be assembled; and

FIG. 6 shows a complete base according to the invention;

As can be seen from the figures the office chair base according to the invention comprises a plurality of spokes 2 extending radially from a central ring 4 into which the column for supporting the seating portion and back-rest is inserted.

The base of the invention is formed by structurally joining together (for example by welding, mechanical coupling, glueing) two plastics concave half-shells hereinafter known as the lower half-shell 6 and the upper half-shell 6′. When joined together, the protrusions of the two half-shells, which are substantially of U cross-section, form spokes of closed cross-section. To facilitate this joining, the two half-shells present longitudinal edges 8, 8′ along the joining region. Each spoke has a greater cross-section in the most stressed region, i.e. at its connection to the ring, and a smaller cross-section in the least stressed region, i.e. close to the wheel connection point. In addition, the cross-section presents a preferably vertical extension, with thinner vertical walls 14, 14′ and thicker upper and lower transverse walls 10, 10′.

Moreover, both the lower half-shell and the upper half-shell are provided along their horizontal portion 10, 10′ with a plurality of stiffening ribs 12, 12′.

All this means that at each cross-section the surface of the vertical portions 14, 14′ is much less than the surface of the horizontal portion 10, 10′ plus the ribs 12, 12′. This type of cross-section enables distribution of the material to be optimized by increasing its use in the more stressed regions, i.e. within the upper and lower portions, and reducing it within the lateral vertical portions.

To prevent the spokes from undergoing undesirable opening-out during stressing, transverse ribs (not shown in the drawings) are also provided.

The part can be further stiffened by using ribs in the region most distant from the neutral axis and suitably distancing the sides of the upper and lower sections from the neutral axis.

The closed cross-section resulting from joining together the two half-shells also determines a greater resistance to twisting.

From the aforegoing it is apparent that the chair base according to the invention presents the advantage, given its greater strength, of a product with superior mechanical performance for the same material, or for equal performance enables the quantity of material to be reduced, or a material with inferior characteristics to be chosen, with a competitive advantage in terms of cost.

1. A method for forming rotatable bases for offices chairs characterised by firmly coupling together at least two half-shells (6, 6′) to form overall a plurality of spokes (2), each consisting of an elongated monolithic box-shaped body, and a central ring (4) into which a column is inserted.

2. A method as claimed in claim 2 characterised by forming each spoke of each half-shell of substantially U-shape with the cavities of the spokes of one half-shell facing the cavities of the spokes of the other half-shell.

3. A method as claimed in claim 1, characterised in that the two half-shells are joined together by welding.

4. A method as claimed in claim 1, characterised in that the two half-shells are joined together by glueing.

5. A method as claimed in claim 1, characterised in that the two half-shells are joined together by mechanical coupling.

6. An office chair base comprising a plurality of spokes radially extending along different angles, from a central ring into which is inserted a column supporting a chair seat, characterized in that each arm consists of at least two portions firmly coupled to each other so as to form a monolithic box-shaped body.

7. A base for office chairs, as claimed in claim 6 characterised in that each half-shell is substantially of U-shape with the cavities of the spokes of one half-shell facing the cavities of the spokes of the other half-shell.

8. A base as claimed in claim 6, characterised in that for every cross-section, each half-shell presents lateral vertical portions (14, 14′) of lesser thickness than the thickness of the horizontal portion (10, 10′).

9. A base as claimed in claim 6, characterised in that each half-shell presents ribs (12, 12′) which are transverse and/or longitudinal to the axis of the spoke.

10. A base as claimed in claim 6, characterised in that each spoke (2) presents a total cross-section which narrows from the centre to the wheel connection point.

11. A base as claimed in claim 6, characterised in that the two half-shells present a projecting edge (8, 8′) extending along their entire length.

12. A base as claimed in claim 6, characterised by being formed of plastic material.
